(19) United States
(12) Patent Application Publication
(10) Pub. No.: US 2012/0217228 A1
(43) Pub. Date: Aug. 30, 2012

(54) COIL MANUFACTURING DEVICE AND METHOD

(75) Inventors: Akikazu Kitagawa, Osaka-shi (JP); Yosuke Yamazaki, Osaka-shi (JP); Toshiya Takenaka, Osaka-shi (JP); Toshiroh Hamakita, Osaka-shi (JP); Masaki Mikata, Osaka-shi (JP)

(73) Assignee: HITACHI ZOSEN CORPORATION, Osaka-shi, Osaka (JP)

(21) Appl. No.: 13/499,877

(22) PCT Filed: Aug. 11, 2010
(86) PCT No.: PCT/JP2010/063613

§ 371 Date: May 7, 2012

(30) Foreign Application Priority Data
Oct. 2, 2009 (JP) 2009-230882

(51) Int. Cl. B23K 26/20

(52) U.S. Cl. 219/121.64; 219/121.63

(57) ABSTRACT

Manufacturing a coil with high precision and high efficiency. Device for manufacturing a coil 3 by welding U-shaped pipes 2 at both ends of a plurality of straight pipes 1. Providing a laser welding head 11 which uses a condensing lens 15 having a focal length at least twice the diameter of the pipes 1, 2 to be welded, to perform welding by irradiating a laser light 13 onto the straight pipes 1 held in position by a workpiece setting jig 24, and onto a joint position w of U-shaped pipes 2 which are temporarily fitted to both ends of the straight pipes 1. Making it possible to manufacture a coil with high precision and high efficiency, without using a filler wire.

### TECHNICAL FIELD

The present invention relates to a manufacturing device for the highly precise and highly efficient manufacture of a winding pipe (referred to below as a “coil”) which has U-shaped pipes connected to both ends of straight pipes for use in boilers and the like, and a manufacturing method which uses this manufacturing device.

### BACKGROUND ART

In the past, a winding pipe such as a coil was manufactured by bending long tubes having straight pipes serially welded to each other. However, if the thickness of the tubes exceeded 4 mm, defects such as wrinkles occurred at the bending sites when the welds of the straight pipes were bent, and it was difficult to bend them into a desired shape.

Accordingly, coils with a thickness exceeding 4 mm were manufactured, for example, by welding 180° elbows to both ends of the straight pipes (e.g., Patent Reference 1). However, in the invention disclosed in Patent Reference 1, when 180° elbows or U-shaped pipes 2 were connected to both ends of straight pipes 1 to manufacture a coil 3 as shown in FIG. 8, it was difficult to vertically weld to adjacent parts 1a of the adjacent straight pipes 1.

Additionally, in the manufacture of coils used in boilers and the like, it is desirable that the inner surface of the coils (in particular, the inner surface of the weld between a straight pipe and a U-shaped pipe) be extremely flat, in order to lower the pipe resistance and the stress concentration.

Excess weld metal on the inner surface of the weld between the straight pipe and the U-shaped pipe can be stably obtained if automatic TIG welding is used, but a joint geometry must be formed in a U-shape, as shown in FIG. 9, in order to obtain good weld quality around the entire circumference (Patent Reference 2). The TIG welding speed is on the order of 7 cm/min, so the productivity is very poor. Moreover, multi-layer welding is required when performing TIG welding on a thick pipe, as shown in FIG. 10, and there is a possibility that the height of the excess weld metal will increase on the inner surfaces, since a filler wire must be added starting with the second pass.

### PRIOR ART REFERENCES

### Patent References

Patent Reference 1: Japanese Patent Application Kokai Publication No. S59-110426

Patent Reference 2: Japanese Patent Application Kokai Publication No. H09-19767

### SUMMARY OF THE INVENTION

### Problems to be Solved by the Invention

The problems to be solved by the present invention are: (1) A joint geometry must be formed in a U-shape when manufacturing a coil with U-shaped pipes joined at both ends of straight pipes using TIG welding; (2) the productivity is very poor; and (3) there is a possibility that the height of the excess weld metal will increase on the inner surfaces.

### Means for Solving these Problems

The coil manufacturing device of the present invention is a device for manufacturing a coil by welding U-shaped pipes at both ends of a plurality of straight pipes, having as its most essential feature that it is provided with a laser welding head which uses a condensing lens having a focal length at least twice the diameter of the pipes to be welded, to perform welding by irradiating laser light onto the straight pipes held in position by a workpiece setting jig, and onto a joint position of U-shaped pipes which are temporarily fitted to both ends of the straight pipes, so as to make possible highly precise and highly efficient manufacture.

Using the coil manufacturing device of the present invention, it becomes possible to easily weld adjacent parts of adjacent pipes, because laser welding is performed by irradiating laser light with a condensing lens having a focal length at least twice the diameter of the pipes to be welded, and with the straight pipes being held in position by a workpiece setting jig.

In the coil manufacturing device of the present invention, if a camera is provided to the laser welding head to ascertain the joint positions of the straight pipes and the U-shaped pipes, then it becomes possible to perform stable welding without deviation, since the irradiation position for the laser light is determined with precision.

In cases where pre-heating is required in the coil manufacturing device of the present invention, a pre-heating device is provided to pre-heat the joint position of the straight pipes and the U-shaped pipes. If this pre-heating device is, for example, a high-frequency pre-heating device having an elliptical or oval high-frequency coil having a cross-section oriented orthogonally to the lengthwise direction of the straight pipes and 5-50 mm greater than an ellipse circumscribing the U-shaped pipes, then highly efficient pre-heating can be performed by surrounding the U-shaped pipes with high-frequency coils. It is desirable to provide the pre-heating device with a noncontact thermometer to measure the temperature of the straight pipes and the U-shaped pipes, because that makes it possible to accurately determine whether or not the temperature at the welding position is the desired temperature when pre-heating is completed.

The coil manufacturing method of the present invention is a method for manufacturing a coil by using the coil manufacturing device of the present invention to weld U-shaped pipes to both ends of a plurality of straight pipes, having as its most essential features: using a high-frequency coil arranged so as to surround the U-shaped pipes which are temporarily fitted to both ends of the straight pipes, to perform induction heating of the straight pipes and the U-shaped pipes up to a specified temperature; ascertaining that the temperature of the induction-heated straight pipes and the U-shaped pipes has reached a specified temperature; and then performing welding by irradiating laser light onto a joint position between the straight pipes and the U-shaped pipes using a condensing lens having a focal length at least twice the diameter of the pipes to be welded.

### Advantages

According to the present invention, a coil can be manufactured with high precision and efficiency, without using a filler wire, because it is possible to perform laser welding on adjacent parts of adjacent straight pipes.

### BRIEF DESCRIPTION OF THE DRAWINGS

FIG. 1 is a drawing illustrating an I-shaped joint during laser welding.

FIG. 2 is a macrophotograph showing a sectional view of a laser welded portion. The outside of the pipe is at the top, and the inside of the pipe is at the bottom.

FIG. 3 is a drawing showing a sectional view of a coil and a tracing of an optical axis during laser welding.

FIG. 4 is a schematic drawing illustrating an example of a laser welding head used in the present invention.

FIG. 5 is a schematic drawing illustrating an example of a pre-heating device used in the present invention, where (a) is a front view, and (b) is a planar view of a high-frequency coil part.

FIG. 6 is a drawing illustrating a state when a coil is pre-heated using a pre-heating device used in the present invention.

FIG. 7 is a drawing illustrating the positional relationship of the pre-heating device and the laser welding device which form the coil manufacturing device of the present invention, where (a) is a planar view, (b) is a view along the line A-A in (a), and (c) is a view along the line B-B in (a).

FIG. 8 a drawing illustrating the difficulty of vertical welding of adjacent pipes to adjacent parts when manufacturing a coil, where (a) is a front view of a coil, and (b) is a sectional view along A-A in (a).

FIG. 9 is a drawing illustrating a U-shaped joint during TIG welding.

FIG. 10 is a drawing illustrating a laminated state during multi-layer welding during TIG welding.

### DETAILED DESCRIPTION OF THE PREFERRED EMBODIMENTS

In the present invention, the object of manufacturing a coil with U-shaped pipes connected to both ends of straight pipes with high precision and high efficiency is achieved by means of laser welding performed by irradiating laser light with a condensing lens having a focal length at least twice the diameter of the pipes to be welded.

### EXAMPLE

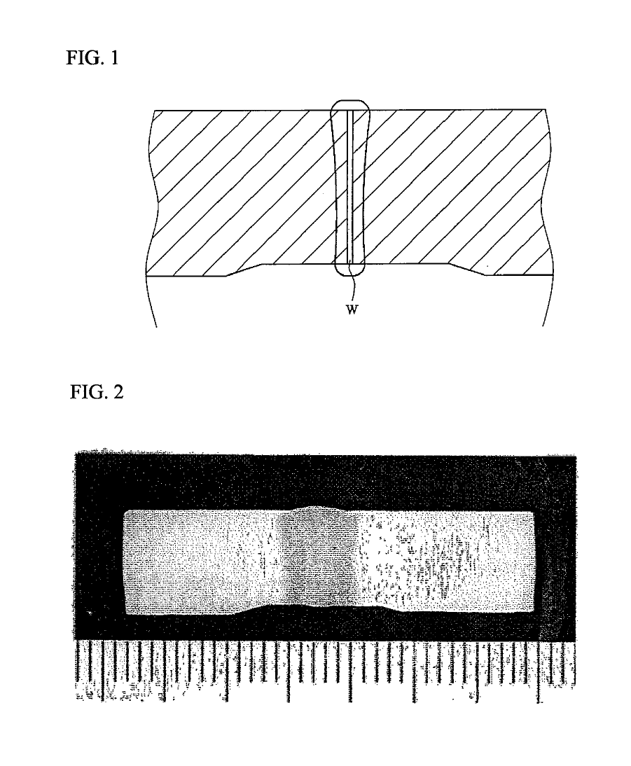

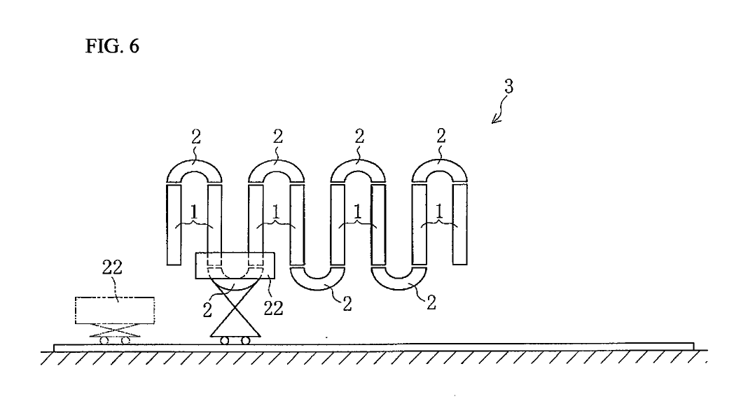

An embodiment of the present invention will be described in detail with reference to FIG. 1 to FIG. 7.

If laser welding is used in manufacturing an 8 mm thick coil having U-shaped pipes connected to both ends of straight pipes, the welding can be performed at a high speed of 70 cm/min, with a simple I-shaped joint w as shown in FIG. 1, and with a low bead height on the inner surface, as shown in FIG. 2.

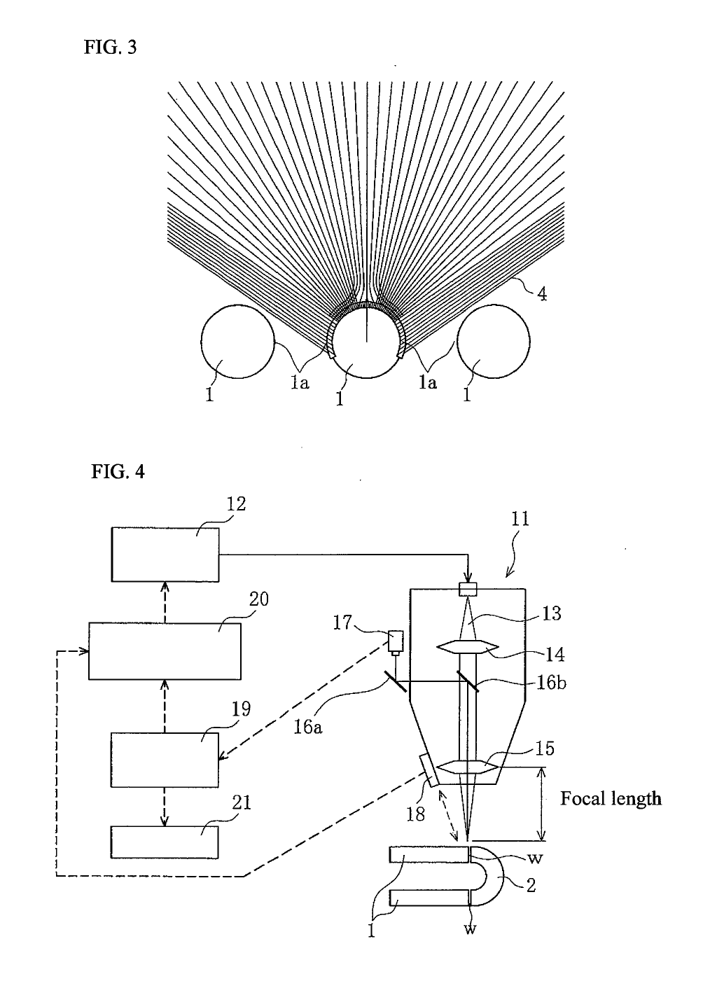

However, it is difficult to vertically irradiate a laser light 4 onto the parts 1a adjacent to the straight pipes 1, at a position near to the adjacent straight pipes 1, as shown in FIG. 3, because the interval L (see FIG. 8) between the adjacent straight pipes of the coil approaches 88.9 mm, for example. In addition, the welding position must be accurately determined, because in laser welding, the laser light is focused onto a small area and the energy density is raised.

Accordingly, in the present invention, welding of straight pipes 1 and U-shaped pipes 2 temporarily fitted to both ends of the straight pipes 1, is performed by irradiating laser light using a condensing lens having a focal length at least twice the diameter d of the pipes 1 and 2 which are to be welded.

Thus, if a condensing lens is used which has a focal length at least twice the diameter d of the pipes 1 and 2 which are to be welded, it is possible to vertically irradiate laser light onto the adjacent parts 1 a of the adjacent straight pipes 1.

As shown in FIG. 4, a laser welding head 11 is constructed for performing laser welding of the straight pipes 1 and the U-shaped pipes 2, by irradiating a laser light 13 from a laser oscillator 12 onto a joint position w of a weld between the straight pipes 1 and the U-shaped pipes 2, through a collimator lens 14 which converts it to parallel rays, and through a condensing lens 15.

In the example shown in FIG. 4, reflecting beam splitters 16a and 16b are arranged on the optical axis of the laser light 13 between the collimator lens 14 and the condensing lens 15, which allows the laser light to pass but reflects visible light, so that the joint positions w between the straight pipes 1 and the U-shaped pipes 2 are photographed with a camera 17. The camera 17 and the beam splitter 16a are attached to the outside of the laser welding head 11.

Since the joint positions w between the straight pipes 1 and the U-shaped pipes 2 are photographed with a camera 17 in this manner, it is possible to accurately ascertain the position for irradiating the laser light 13 which is focused on the order of 0.5 mm. Therefore, stable laser welding can be performed without deviation.

Moreover, in the example shown in FIG. 4, a noncontact thermometer 18 is provided for measuring the temperature of the joint positions w between the straight pipes 1 and the U-shaped pipes 2 prior to laser welding. If such a noncontact thermometer 18 is provided, it is possible to determine whether or not the temperature of the joint positions w between the straight pipes 1 and the U-shaped pipes 2 which are to be welded, has reached a specified temperature.

In FIG. 4, Reference Numeral 19 is a processor for processing images taken by the camera 17. Reference Numeral 20 is a laser controller responsive to inputs of the images processed by the image processor 19, as well as the temperatures measured by the noncontact thermometer 18 to control the laser oscillator 12. Reference Numeral 21 is a monitor which displays the images of the image processor 19.

Incidentally, in laser welding, the intrinsic properties of the welded materials readily undergo change, because they are heated more rapidly than in TIG welding. Therefore, it is desirable to pre-heat the materials to be welded prior to welding, so as to prevent changes from occurring. This pre-heating also has the effect of preventing weld cracks and ensuring a suitable structure, because it is able to reduce the harmful effects of rapid heating and cooling.

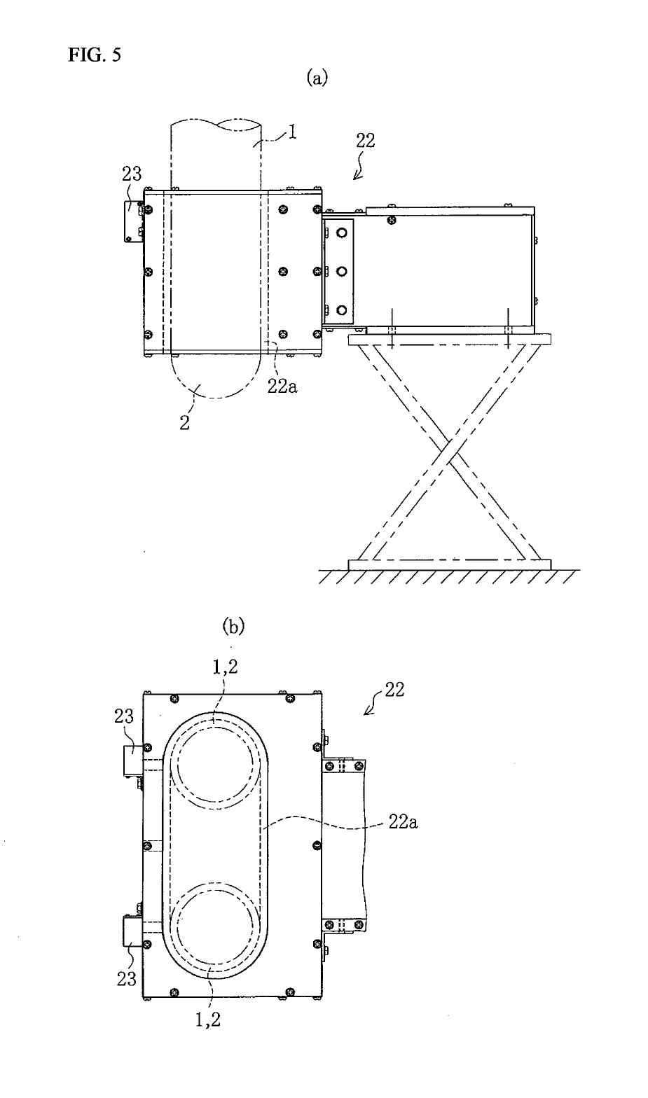

Accordingly, in this Example, there is provided a pre-heating device 22 such as that shown in FIG. 5, for pre-heating the joint positions w of the straight pipes 1 and the U-shaped pipes 2. In this Example, the pre-heating device 22 is a high-frequency pre-heating device having an elliptical high-frequency coil 22a, wherein a cross-section oriented orthogonally to the lengthwise direction of the straight pipes is 5-50 mm greater than an ellipse circumscribing the U-shaped pipes.

If the distance of the high-frequency coil 22a, which is greater than an ellipse circumscribing the U-shaped pipes 2, is less than 5 mm, then the high-frequency coil 22a can readily make contact with the U-shaped pipes 2 when setting up for pre-heating. On the other hand, if the distance exceeds 50 mm, then the weld portion is at too far of a distance from the high-frequency coil 22a, thus making it difficult to pre-heat to the specified temperature. Therefore, the distance should be 5-50 mm.

If such a high-frequency coil 22a is used, the high-frequency coil 22a surrounds the U-shaped pipe 2, thereby making it possible to perform pre-heating with favorable efficiency. If, for example, a radiation thermometer 23 is provided to measure the temperature of the straight pipes 1 and the U-shaped pipes 2 in the pre-heating device 22, as shown in FIG. 5, then there is feedback on the temperature which is monitored by the radiation thermometer 23, making it possible to precisely control the temperature at the welding position.

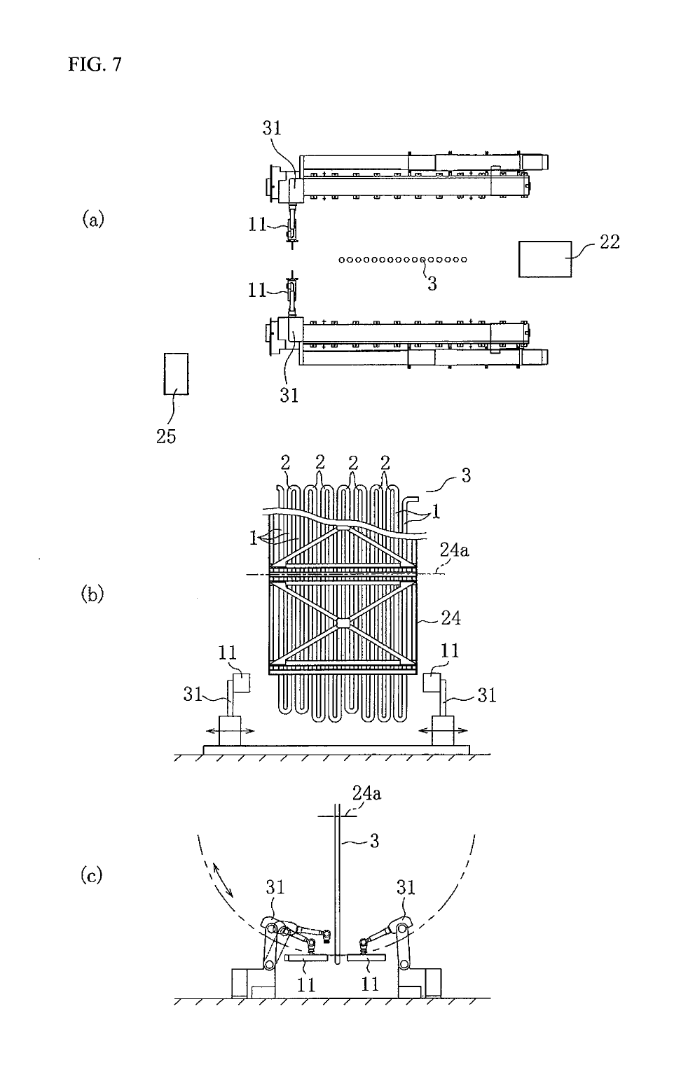

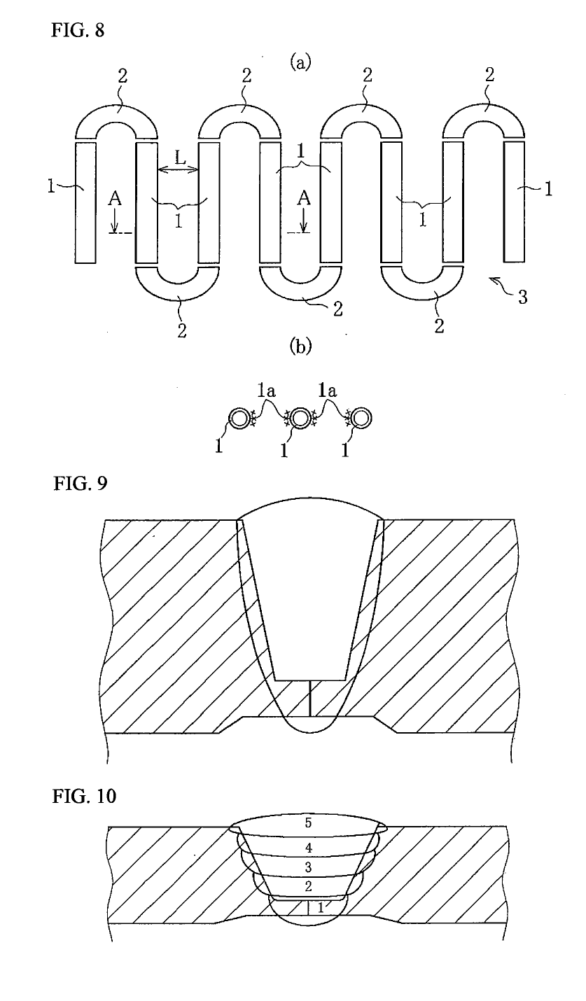

As shown in FIG. 7, the pre-heating device 22 is positioned in a withdrawn position on an extended line along which the straight pipes 1 and the U-shaped pipes 2 are arranged and held in position by a workpiece setting jig 24. During pre-heating, it is desirable to move the pre-heating device 22 to the pre-heating position, and then to raise it, so as to perform pre-heating.

Moreover, in this Example, as shown in FIG. 7, two laser welding devices 31 to which are attached the laser welding heads 11 to be freely moving (rotating), are positioned on both sides of the straight pipes 1 and the U-shaped pipes 2 so that the straight pipes 1 and the U-shaped pipes are interposed between them, and are oriented orthogonally to the direction in which the straight pipes 1 and the U-shaped pipes 2 are lined up and held in position by the workpiece setting jig 24. These two laser welding devices 31 are each provided to freely move in the direction in which the straight pipes 1 and the U-shaped pipes 2 are lined up.

Due to the fact that the two laser welding devices 31 arranged in this manner are moved in the direction in which the straight pipes 1 and the U-shaped pipes are lined up, and the laser welding heads 11 are used to perform continuous welding from both sides of the straight pipes on each joint of the straight pipes 1 and the U-shaped pipes 2 one by one, it is possible to quickly and efficiently manufacture the coil 3.

As shown by the arrows in FIG. 7 (c), it is desirable for the workpiece setting jig 24, which holds in place the straight pipes 1 and the U-shaped pipes 2, to have an invertible structure centered at a fulcrum 24a, to make it possible to reverse the position of the U-shaped pipes 2 which are temporarily fitted to both ends of the straight pipes 1. In FIG. 7, Reference Numeral 25 is a control panel.

If arranged in this manner, after completing welding of the U-shaped pipes 2 at one end of the straight pipes 1, preparation for welding the U-shaped pipes 2 at the other end of the straight pipes 1 is accomplished simply by inverting the workpiece setting jig 24, thereby making it possible to form joints at the other end by using the same operation.

Following is a description of the coil manufacturing method of the present invention, which uses the coil manufacturing device of the present invention constituted as described above.

1) The straight pipes 1 with the U-shaped pipes 2 temporarily fitted to both ends are set up in the workpiece setting jig 24.

2) The approximate position of the straight pipes 1 with the U-shaped pipes 2 temporarily fitted to both ends and set in the workpiece setting jig 24 is input into the control panel 25.

3) If pre-heating is required, the pre-heating device 22 is caused to move, to raise the pre-heating device 22 so that the weld is surrounded by the high-frequency coil 22a, and preheating (induction heating) is carried out in accordance with a program.

4) Once pre-heating is completed in accordance with the program, the pre-heating device 22 is lowered and moved to a withdrawn position.

5) After moving the two laser welding heads 11 to the approximate respective positions input to the control panel 25, the image of the welding position photographed by the camera 17 is processed to ascertain precise welding coordinates.

6) After that, each laser welding head 11 is withdrawn to a position at which the temperature of each weld can be measured by the noncontact thermometer 18, and then the temperature of each weld is measured.

7) Once it is confirmed that the temperature of the weld has reached the specified temperature, each laser welding head 11 is moved to the precise welding position, and laser welding is then performed in accordance with the welding conditions predetermined by the program.

8) The sequence 3)-7) set forth above is repeated at one end of all of the strait pipes 1 which are held in place by the workpiece setting jig 24, and to which the U-shaped pipes 2 have been temporarily fitted to both ends.

9) After completing the welds at one end of the straight pipes 1, the workpiece setting jig 24 is inverted, and the U-shaped pipes 2 are likewise welded to the other end of the straight pipes 1.

The present invention is not limited to the above Example, and the preferred embodiment may, of course, be advantageously modified within the scope of the technical ideas recited in the claims.

For example, the above Example describes the raising and lowering of the pre-heating device 22 when pre-heating, but it is also acceptable to raise and lower the workpiece setting jig 24, which holds the straight pipes 1 having the U-shaped pipes 2 temporarily fitted to both ends.

The welding operation is not limited to an automated operation, and may be performed while the welder makes a verification at each step.

### INDUSTRIAL APPLICABILITY

As long as the present invention is used in welding adjacent pipes, it is not limited to the manufacture of the coil 3 having U-shaped pipes connected to both ends of straight pipes for use in boilers and the like.

### EXPLANATION OF THE REFERENCE SYMBOLS

1 Straight pipe
1a Adjacent part
2 U-shaped pipe
3 Coil
11 Laser welding head
13 Laser light
15 Focus lens
16a, 16b Beam splitters
17 Camera
22 Pre-heating device
22a High-frequency coil
23 Radiation Thermometer
24a Fulcrum
31 Laser welding device

1. A device for manufacturing a coil by welding U-shaped pipes at both ends of a plurality of straight pipes, comprising:
a laser welding head which uses a condensing lens having a focal length at least twice the diameter of the pipes to be welded, to perform welding by irradiating laser light onto the straight pipes held in position by a workpiece setting jig, and onto a joint position of U-shaped pipes which are temporarily fitted to both ends of the straight pipes.

2. The device for manufacturing a coil according to claim 1, wherein a camera is provided to the laser welding head to ascertain the joint positions of the straight pipes and the U-shaped pipes.

3. The device for manufacturing a coil according to claim 1, wherein two laser welding heads are provided on both sides of the straight pipes and are oriented orthogonally to the direction in which the straight pipes and the U-shaped pipes are lined up to be welded, and which are respectively provided to freely move in the direction in which the straight pipes and the U-shaped pipes are lined up.

4. The device for manufacturing a coil according to claim 1, wherein a pre-heating device is provided to pre-heat the joint positions of the straight pipes and the U-shaped pipes.

5. The device for manufacturing a coil according to claim 3, wherein a pre-heating device is provided to pre-heat the joint positions of the straight pipes and the U-shaped pipes.

6. The device for manufacturing a coil according to claim 4, wherein the pre-heating device is a high-frequency pre-heating device having an elliptical or oval high-frequency coil having a cross-section oriented orthogonally to the lengthwise direction of the straight pipes and 5-50 mm greater than an ellipse circumscribing the U-shaped pipes.

7. The device for manufacturing a coil according to claim 5, wherein the pre-heating device is a high-frequency pre-heating device having an elliptical or oval high-frequency coil having a cross-section oriented orthogonally to the lengthwise direction of the straight pipes and 5-50 mm greater than an ellipse circumscribing the U-shaped pipes.

8. The device for manufacturing a coil according to claim 4, wherein the pre-heating device is a provided with noncontact thermometer to measure the temperature of the straight pipes and the U-shaped pipes.

9. The device for manufacturing a coil according to claim 5, wherein the pre-heating device is a provided with noncontact thermometer to measure the temperature of the straight pipes and the U-shaped pipes.

10. The device for manufacturing a coil according to claim 1, wherein the workpiece setting jig has an invertible structure which makes it possible to reverse the position of the U-shaped pipes which are temporarily fitted to both ends of the straight pipes.

11. The device for manufacturing a coil according to claim 3, wherein the workpiece setting jig has an invertible structure which makes it possible to reverse the position of the U-shaped pipes which are temporarily fitted to both ends of the straight pipes.

12. The device for manufacturing a coil according to claim 4, wherein the workpiece setting jig has an invertible structure which makes it possible to reverse the position of the U-shaped pipes which are temporarily fitted to both ends of the straight pipes.

13. The device for manufacturing a coil according to claim 5, wherein the workpiece setting jig has an invertible structure which makes it possible to reverse the position of the U-shaped pipes which are temporarily fitted to both ends of the straight pipes.

14. The device for manufacturing a coil according to claim 9, wherein the workpiece setting jig has an invertible structure which makes it possible to reverse the position of the U-shaped pipes which are temporarily fitted to both ends of the straight pipes.

15. A coil manufacturing method for manufacturing a coil by welding U-shaped pipes to both ends of a plurality of straight pipes, comprising:
induction heating the straight pipes and the U-shaped pipes up to a specified temperature, by using a high-frequency coil arranged so as to surround the U-shaped pipes which are temporarily fitted to both ends of the straight pipes;
ascertaining that the temperature of the induction-heated straight pipes and the U-shaped pipes has reached a specified temperature; and
performing welding by irradiating laser light onto a joint position between the straight pipes and the U-shaped pipes using a condensing lens having a focal length at least twice the diameter of the pipes to be welded.
